(19) United States
(12) Patent Application Publication
(10) Pub. No.: US 2023/0182060 A1
(43) Pub. Date: Jun. 15, 2023

(54) COFORM NON-WOVEN HEPA FILTER MEDIA AND METHOD FOR MAKING SAME

(71) Applicant: VERDEX TECHNOLOGIES INC., Richmond, VA (US)

(72) Inventors: Johan Olof Brag, Westport, CT (US); Larry Marshall, Chesterfield, VA (US)

(73) Assignee: VERDEX TECHNOLOGIES INC., Richmond, VA (US)

(21) Appl. No.: 17/548,337

(22) Filed: Dec. 10, 2021

(51) Int. Cl. B01D 46/54; B01D 46/00

(52) U.S. Cl. CPC B01D 46/546; B01D 46/0001; B01D 46/0028; B01D 2239/025; B01D 2239/0442; B01D 2239/1208; B01D 2239/1233; B01D 2257/91; B01D 2279/65

(57) ABSTRACT

A high efficiency particulate air filter for the capture of virus particles is disclosed. The filter includes a coform three-dimensional fibrous matrix comprising a population of fibrillated polymeric nanofibers and a population of microparticles homogenously distributed throughout the fibrous matrix. In an embodiment, the microparticles are ion exchange resins. The virus particles are captured by the fibrous matrix and bind to the to the surface of the resins by permanent electrostatic forces and inactivated by the biocidal agent. A process for removing virus particles from an aerosol is also disclosed. The filter provides at least a log₁₀ reduction value (LRV) greater than 3 for virus particles with a diameter smaller than 0.3 microns with a pressure drop of less than 200 Pascal at an aerosol face velocity of 5.3 cm/s.

This application is a continuation of U.S. Provisional Pat. Application 63/124056

### TECHNICAL FIELD

This application generally relates to high efficiency particulate air filters and more specifically to filters made from polymeric nanofibers.

### DESCRIPTION OF THE RELATED ART

High-Efficiency Particulate Air or HEPA is a type of air filter. Filters that are awarded the HEPA accolade are used in various locations, whether in medical facilities, automotive vehicles, airplanes, home filters, or wherever very pure air is sought. The filter must satisfy certain standards of efficiency such as those set by the United States Department of Energy (DOE). To qualify as HEPA by government standards, an air filter must remove 99.97% of all particles greater than 0.3 micrometer from the air that passes through. The filter’s minimal resistance to airflow, or pressure drop, is usually specified around 300 Pa at its nominal flow rate. The specification usually used in the European Union is the European Norm EN 1822:2009. It defines several classes of HEPA filters by their retention at the given Most Penetrating Particle Size (MPPS).

Theoretically, a reduction of the diameter of the fibers in a filter has the potential of causing an improvement of the filter system performance. For high efficiency filtration, fiberglass wet-laid papers are widely used having fiber diameters in the 200 nm to 5000 nm size range with the fiber sizes intentionally blended for both durability and filtration performance.

Polymeric nanofibers have found various commercial applications in air filtration over the last three decades owing to their unique fiber size, which can broadly be defined as having submicron fiber diameter. In particular, these polymeric nanofiber matrices provide comparable performance to other commercially available HEPA media composed of sub-micron glass or expanded-PTFE membranes. In many of these applications, a nanofiber layer was designed to have a thickness equal to only several nanofiber diameters and was laid on a fibrous substrate that additionally serves as a safety filter. The thinness of the nanofiber layer coupled with fiber density considerably increases the fractional efficiency of the filter media with no significant negative impact on permeability to air flow.

Polymeric nanofibers can be made using a variety of different technologies; one such process is electrospinning. Electrospinning technology utilizes electrical charges to deform, accelerate and elongate a volume of polymer solution into a fibrous shape. Typically, the solution is held at the tip of a capillary by its surface tension and subjected to a strong electric field generated between a ground potential and the charged volume of polymer solution.

However, electrospun nanofibers smaller than 500 nm are typically fragile, difficult to produce, and difficult to handle. In the most common use, very thin polymer nanofiber webs have been applied as second layer on top of a lower efficiency substrate media to create a composite filter media. The substrate media typically have good mechanical handling characteristics and economics, with relatively poor filtration efficiencies. The addition of a nanofiber web to the surface enhances the efficiency of the base material, creating a composite media with good handling properties and good efficiency for many industrial and engine-related applications. For instance, U.S. Pat. 7,008,465 to Graham et al. teaches a filter media comprising a nanofiber layer and a high efficiency substrate layer; the nanofiber layer comprising a polymer material and having a fiber diameter of about 0.01 to 0.5 micron, a basis weight of about 3×10⁻⁷ to 6×10⁻⁵ g.cm⁻², an average pore size of about 0.01 to 100 microns and a thickness of about 0.05 to 50 microns; the high efficiency substrate layer comprising a non-woven layer.

One conventional approach has been to deposit nanofibers onto a conventional porous filter media to make a layered nano fiber filter media. Conventional layered nanofiber filters made from nanofibers deposited on conventional porous filter media have inherent limitations. The support media of these filters is usually pliable enough to allow pleating or manipulation during the assembly step. Such a pliable substrate media may flex or stretch from the air pressure drop force and may break or debond the nanofibers. The support layer of conventional media may contribute substantially to the pressure drop of the whole structure.

There is therefore a need for a monolithic filter media with constant QF throughout the layers of the media.

There is also a need for filter media combining both strong mechanical properties as well as high porosity and particle capture efficiency.

A particle deposition process distinct from the actual fiber production process cannot ensure a filter media with a constant resistance to pressure across the surface of the material. There is therefore a need for a single step production system where resistance is uniform across the entire media surface.

There is also a need for low-cost, high efficiency particle air filters produced at high line speeds using a wide range of polymers.

### SUMMARY OF THE DISCLOSURE

The subject matter of the present disclosure is directed to a composite nanofibrous material for use in high efficiency particulate air (HEPA) filtration systems with improved capture efficiency of submicron particles. Polymeric nanofiber materials are known, however their use in HEPA filtration devices has been very limited due to high pressure drop and poor tensile strength under high air pressure. The fibrous matrix of the disclosure addresses these limitations by offering high capture efficiency with a low pressure drop and can therefore be use in a very wide variety of air filtration systems in hospitals (such as operating rooms, intensive care units and laboratories and clean rooms, analysis laboratories), chemical and pharmaceutical companies, electronics companies, aerospace, in the nuclear industry and in some air scrubbers.

We disclose a filtration media comprising a coform fibrous matrix comprising a first population of fibrillated polymeric nanofibers and a second population of microparticles homogenously dispersed throughout the fibrous matrix, where the permeability of the coform fiber matrix is greater than the permeability of a fibrous matrix comprising the first population of nanofibers formed without the second population of microparticles and where the porosity of the coform fiber matrix is less than the porosity of a fibrous matrix filter comprising the first population of nanofibers formed without the second population of fine particles.

In an embodiment of the disclosure, the filter provides a capture efficiency greater than 99.9%, preferably greater than 99.99%. for particles with a median diameter of less than 0.3 microns and a pressure drop of less than 200 Pascal at an airstream face velocity of 5.3 m/s. The filter includes a coform matrix comprising a population of fibrillated polymeric nanofibers and a population of polymeric microparticles homogeneously dispersed throughout the coform matrix. The particles are thermally bound to the surface of the fibers without the need for binders. In a preferred embodiment, the microparticles are ion exchange (IEX) resins.

In another embodiment of the disclosure, a filter material for the capture, binding and inactivation of bioactive airborne particles from an aerosol is disclosed. The filter includes a coform three-dimensional fibrous matrix comprising a population of fibrillated polymeric nanofibers and a population of microparticles homogenously distributed throughout the matrix, where the particles include porous IEX resins impregnated with a biocidal agent. The bioactive airborne particles are captured by the fibrous matrix, bind to the to the surface of the resins by permanent electrostatic forces and are inactivated by the biocidal agent. In a preferred embodiment, the biocidal agent is selected from iodine, bromine, propanol, ethanol, isopropyl alcohol and benzalkonium chloride.

In an embodiment of the disclosure a process for filtering electrically charged nanoparticles from an aerosol is disclosed. The process includes the steps of passing the aerosol through a coform fibrous matrix comprising a population of fibrillated polymeric nanofibers and a population of ion exchange resins homogenously dispersed throughout the matrix, capturing the virus particles in the coform matrix, binding the virus particles to the surface of the ion exchange resins by electrostatic forces, desiccating the virus particles on contact with the ion exchange resins, where the filter provides at least a log10 reduction value (LRV) greater than 3 for virus particles with a diameter smaller than 0.3 microns with a pressure drop of less than 200 Pascal at an aerosol face velocity of 5.3 cm/s.

The resins have a median size of in diameter smaller than the median pore size of the fibrous matrix. In a preferred embodiment, the resins have an average diameter of less than 65 microns preferably less than 35 microns. providing for greater particle surface area.

In a preferred embodiment, the resins include strongly acidic cation exchange resins. In a more preferred embodiment, the cation exchange resins comprise sulphonated cross-linked polystyrene derivatives with a degree of crosslinking greater than 8%, preferably greater than 10%.

In another embodiment, the resins include a mixture of anion exchange and cation exchange resins.

In still another embodiment, the fibrous matrix includes a population of polymeric microfibers dispersed homogeneous within the coform matrix, with an average diameter between 2 and 5 microns.

In another embodiment, the resins comprise at least 50% by weight of the fibrous layer.

In still another embodiment, the fibrous matrix has a porosity greater than 85%.

In an embodiment of the present disclosure, a filtration media is engineered to include a nanofibrous matrix layer comprising a first population of melt-film fibrillated nanofibers. In a preferred embodiment, the median diameter of the nanofibers is less than 500 nm.

### BRIEF DESCRIPTION OF THE DRAWINGS

The disclosure, together with further objects and advantages thereof, may best be understood by reference to the following description taken in connection with the accompanying drawings.

FIG. 1 is an illustration of an ion exchange resin according to the disclosure.

FIG. 2 is an illustration of the process for making the material according to the disclosure

FIG. 3 illustrates upstream vs downstream viral concentrations from a plurality of filter media according to the disclosure.

FIG. 4 illustrates the percentage reduction in viable virus bio-aerosol reduction.

FIG. 5 illustrates the capture efficiency as a function of particle size for a first sample.

FIG. 6 illustrates the capture efficiency as a function of particle size for a second sample.

FIG. 7 illustrates the capture efficiency as a function of particle size for a third sample.

FIG. 8 illustrates the capture efficiency as a function of particle size for a fourth sample.

FIG. 9 is a first illustration of fiber distribution relative to a filter of the prior art.

FIG. 10 is a second illustration of fiber distribution relative to another filter of the prior art

FIG. 11 is an SEM picture of a portion of a bimodal 3 D matrix according to disclosure.

FIG. 12 illustrates the fiber size distribution of a bimodal 3D matrix according to the disclosure.

FIG. 13 is an SEM picture of a fiber matrix with resins distributed throughout the matrix according to the disclosure.

FIG. 14 is another SEM picture of a fiber matrix with resins distributed throughout the matrix according to the disclosure.

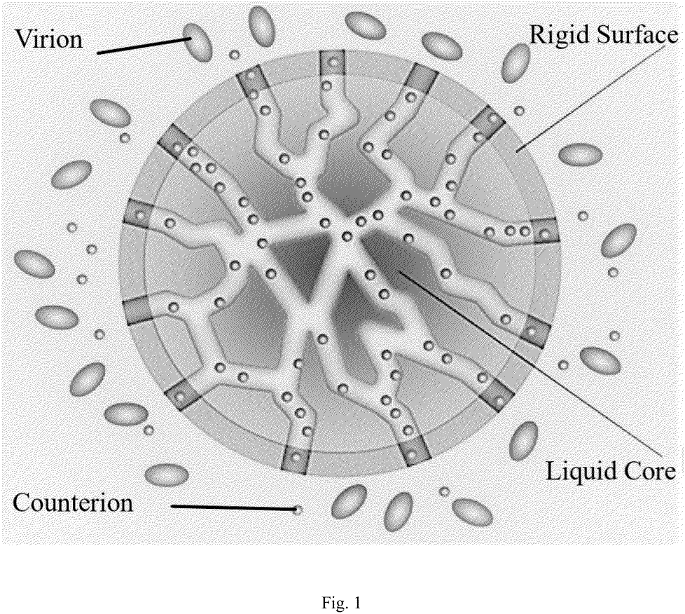

### DEFINITIONS

As used herein, the term “coform nonwoven matrix” or “coform material” means composite materials comprising a mixture of thermoplastic filaments and at least one additional material, usually called the “second material”. As an example, coform materials may be made by a process such as melt film fibrillation where a the second material is added to the non-woven matrix while it is forming. The second material may be ion exchange resins (IER), superabsorbent particles (SAP), powdered activated carbon (PAC), a liquid solution such as a surfactant or another fiber material from the same or another polymer. Exemplary coform materials are disclosed in commonly assigned U.S. Pat. No 8,808,594 to Marshall et al.; the entire contents of which is hereby incorporated by reference.

As used herein, the term “melt film fibrillated fibers” means fibers formed by having high velocity, usually hot, gas (e.g. air) streams shear a molten polymer film against an edge of a surface producing a plurality of usually submicron filaments which are deposited on a collecting surface to form a matrix of randomly dispersed fibers. Such a process is disclosed, for example, in U.S. Pat. No. 8,668,854 to Marshall et al., which is hereby incorporated by reference in its entirety. Melt film fibrillated fibers are generally tacky when deposited on a collecting surface, may be continuous or discontinuous, and are generally smaller than 1 micron in average diameter.

As used herein, the term “ion exchange resins” refers to polymers that acts as a medium for ion exchange. It is an insoluble matrix normally in the form of microbeads, fabricated from an organic polymer substrate. The beads are typically porous, providing a large surface area on and inside them the trapping of ions occurs along with the accompanying release of other ions, and thus the process is called ion exchange. There are two main types multiple types of ion-exchange resins: cation exchange resins and anion exchange resins. Most commercial cation exchange resins are made of polystyrene sulfonate.

### DETAILED DESCRIPTION

### Nanofiber Matrix

Polymeric nanofibers are known, however their use in filtration has been very limited due to their fragility to mechanical stresses, limited porosity and the susceptibility of nanofiber webs to fuse under applied pressure. The monolithic fibrous layers described in this invention address these limitations and will therefore be usable in a very wide variety of high efficiency air and liquid filtration, membrane and other diverse applications.

We disclose a unique melt-film fibrillation process can produce a filtration medium with high collection efficiency and high permeability where low pressure drop is maintained when multiple layers of fibers are stacked together.

Numerous modifications and variations of the present invention are possible in light of the above teachings. It is therefore to be understood that within the scope of the appended claims, the invention may be practiced otherwise than as specifically described herein.

An ideal particulate filter is the one that would give the highest particle collection efficiency (lowest particle penetration) with the least pressure drop. The current disclosure teaches how the drawbacks of current high efficiency particle air (HEPA) filter media can be overcome by a monolithic filter media comprising a polydisperse distribution of nanofibers and microparticles leading to better filtration efficiency and decreased pressure drop. In a preferred embodiment, a film fibrillation process produces a first uniform distribution of submicron fibers with an median diameter of 500 nm from a first polymer and a second uniform distribution of microparticles with a median diameter of 30 microns and where the first and second distribution are combined into a monolithic homogeneous fibrous layer with a porosity greater than 85%.

It is desirable to have a certain amount of larger fibers throughout the fiber media as it provides a scaffold against which higher pressure can be applied without collapsing the fibrous web. The resistance to pressure is dependent on the percentage of larger fibers contained in the fibrous web. If the percentage is too low the scaffold will collapse and the loftiness of the structure can no longer be maintained. This is turn will increase the pressure drop as porosity drops dramatically together with the closing of pores. On the other hand, if the percentage of large fibers becomes too small then the particle capture efficiency will remain low. Particle capture efficiency is a function of pore size and larger pores will let more particles through. An optimal filtration medium is therefore a medium which combines high porosity together with small pore size and resistance to pressure.

The filter medium of the present invention is comprised of nanofibers that may be organic or inorganic materials including, but not limited to, polymers, engineered resins, cellulose, rayon, glass, metal, activated alumina, carbon nanotubes or graphene, silica, zeolites, or combinations thereof.

Combinations of organic and inorganic fibers are contemplated and within the scope of the invention as for example, polymeric fibers and carbon nanotubes may be used together.

Preferably, a significant portion of the fibers should have a diameter less than or equal to about 1000 nanometers, more preferably less than or equal to about 500 nanometers. When the filter medium is produced by a melt-film fibrillation process from polymeric nanofibers, such fibers should also have a high loft (fill power). Fibrillated fibers are most preferred due to their exceptionally fine dimensions low cost and high efficiency production.

Preferably, fibrillated polymeric nanofibers, processed in accordance with the present disclosure, can produce an ultra-fine filter medium. Polymer materials that can be used in the polymeric compositions of the invention include both addition polymer and condensation polymer materials such as polyolefin, polyacetal, polyamide, polyester, cellulose ether and ester, polyalkylene sulfide, polyarylene oxide, polysulfone, modified polysulfone polymers and mixtures thereof. Preferred materials that fall within these generic classes include polyethylene, polypropylene, poly(vinylchloride), polymethylmethacrylate (and other acrylic resins), polystyrene, and copolymers thereof (including ABA type block copolymers), poly(vinylidene fluoride), poly(vinylidene chloride), polyvinylalcohol in various degrees of hydrolysis Such fibrillated nanofibers can be made by direct melt-spinning of a polymer, such as polyethersulfone (PES), polypropylene (PP), polytetrafluoroethylene (PTFE), polyvinylidene fluoride (PVDF), polyvinylidene chloride (PVDC), and polysulfone (PSU). Furthermore, the fibrillated fibers may be produced in large quantities using equipment of modest capital cost. It will be understood that fibers other than those listed above may be fibrillated to produce extremely fine fibrils.

### Secondary Material

We have found that a coformed filter media made from a melt-film fibrillated nanofiber matrix and a secondary material consisting of microparticles with permanent electrostatic charge dispersed within a non-woven fiber matrix significantly offered improved filtration performance over a non-woven nanofiber matrix alone. While the capture efficiency and pressure drop both decreased with the inclusion of the secondary material, the gain in performance from the lower pressure drop exceed the loss in efficiency.

In air filtration the basic principles of particle deposition on filter media are known as screening, inertial impaction, direct interception and diffusion. Small fibers in the submicron range, in comparison with larger ones, are well known to provide better filter efficiency at the same pressure drop in the interception and inertial impaction regimes. When a polymeric nanofiber web is applied to the upstream (dirty) side of a filter medium, the particulate matter is largely caught at the surface of the nanofiber web. Air flow capacity, which is a function of resistance, or pressure drop across the filter and particle loading, decreases as the dust cake forms on the filter. Consequently, with the dust cake formation the resistance to flow increases. Since nanofiber HEPA filters are typically not cleaned, the air flow rate continues to decrease as the system operates. After the resistance across the filter reaches a threshold limit that prevents adequate air flow, the filter must be replaced.

One of the parameters that is used to compare the performance of different filter media is the Quality Factor (QF), which can be thought of as a benefit to cost ratio, where efficiency is the benefit, and normalized pressure drop (ΔP) is the cost (ΔP / face velocity). The “cost” is normalized so that QF’s from tests run at different velocities can be compared. QF is simply an index to compare media and larger values are better. The formula for calculating QF is:
QF = Log(penetration)/ ΔP /face velocity.
where ΔP is the pressure drop across the medium (Pa) and media face velocity has the unit of cm/s. The penetration is defined as the fractional penetration of a specific aerosol particle diameter:
Penetration = 1 - Efficiency

Porosity of filter media is an important aspect in filtration efficiency. When porosity increases, drag per unit length of fibers decreases as does single fiber particle capture efficiency due to diffusion and interception. When porosity of filter media increases, the pressure drop decreases at a much faster rate than single fiber efficiency. It can be concluded that, within the vicinity of the most penetrating particle size, the QF decreases with decreased porosity.

In a typical nanofiber only configuration, as the amount of nanofibers per surface area is increased, the QF decreases dramatically. Due to their extremely high aspect ratio, nanofibers made using electrospinning typically do not stack on top of each other in discrete layers. Instead, when the amount of nanofibers in a given surface area is very high, they tend to fuse to each other and result in a membrane-like structure with very small pores that limits the air flow capacity without providing high levels of particulate efficiency. Therefore at the current state-of-the-art, conventional layered nanofiber filter media do not provide filters with significantly greater QF than conventional fiberglass media.

To improve particle capture efficiency without significantly increasing the pressure drop across the filter media, various approaches have been developed. U.S. Pat. 8,177,876 to Kalayci et al. teaches the use of polymeric microspheres in an attempt to space the nanofiber layers apart from each other. By doing so, the porosity of the structure has increased as well as the air permeability. In addition, the multi-layered structure resulted in a tortuous path for air flow causing a marked increase in the capture efficiency of challenge particles. A major limitation of the approach is the poor depth filtration capacity of electrospun nanofiber materials and the difficulty of producing a uniform material. It is very difficult to ensure a homogeneous distribution of particulate matter between the nanofiber layers. Some areas of the various layers will still fuse on contact reducing porosity and thereby increasing the pressure drop. Additionally, the structural integrity of the nanofiber layers is degraded by the deposition process. Pliability and mechanical strength of the nanofiber layers is still limited and subject to tearing if stretched or compressed. Finally, the final filter media still requires a separate substrate layer on which to deposit the nanofiber layer. Furthermore, the final material is much thicker than it would without the addition of particles.

We have surprisingly found that by using a lofty, nanofiber matrix, it is possible to increase air permeability without increasing the thickness and porosity of the filtration material. In an embodiment, we use the melt-fibrillation process to produce a lofty, highly pliable nanofiber matrix with high porosity and capture efficiency. We can further improve the quality factor of the material by introducing a secondary material within the pores of the nanofiber matrix. By dispersing a secondary material such as microparticles within the lofty matrix we can produce a material with lower pressure drop and improved quality factor. A preferred embodiment comprises a first nonwoven web of fibrillated polymeric nanofibers having a median diameter of about 500 nanometers and a distribution between 200 nanometers and 1.2 microns to maintain a desired level of efficiency at an acceptable pressure drop and second population of microparticles having a median diameter of 30 microns.

### Virus Filtration Efficiency

In addition to the improvement in capture efficiency the addition of fine ion-exchange resins throughout the coform matrix provides improvements in terms of air permeability and therefore lower pressure drop across the fibrous matrix. The resins provide a scaffold against which higher pressure can be applied without collapsing the nanofiber matrix and reducing pore size. The efficiency and air permeability are dependent upon the surface density and diameter of the resins in the fibrous matrix. If the percentage is too low the scaffold will collapse and the loftiness of the structure can no longer be maintained. This is turn will reduce pore size and increase pressure drop as porosity drops together with the closing of pores. On the other hand, if the percentage of resins becomes too large then efficiency of the filter will be reduced. An optimal filter layer structure is therefore a structure which can maintain its pore size over time.

The capture efficiency of the filters were evaluated against a single RNA virus which was Phi X 174 Bacteriophage which is a commonly used surrogate for the herpes simplex as well as various human pathogenic viruses. Testing was conducted to characterize the amount of viable Phi X 174 bacteriophage that was being removed by each filter. Testing was conducted by cutting 90 mm in diameter circular swatches. Filter swatches were loaded into the filter holder for the bioaerosol challenge testing. Sampling of the aerosol was performed upstream and downstream of the filter holder in order to quantify the amount of bacteriophage that was being removed by the filter. These samples were serially diluted, plated, and then enumerated to generate concentrations.

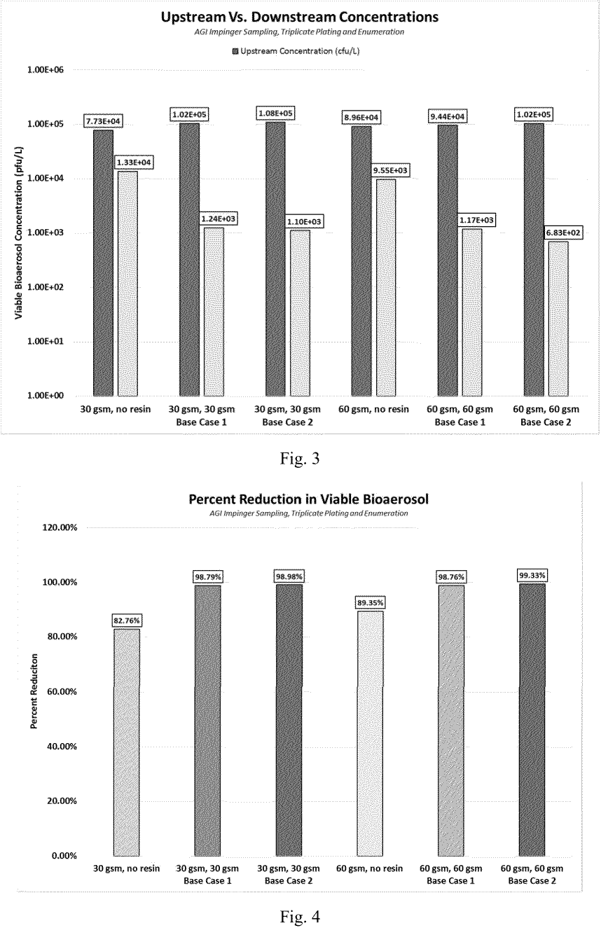

FIGS. 3 and 4 illustrate the results from virus filtration studies. This study was conducted to evaluate the capture efficiency of multiple nanofiber filters. This study tested two different amounts of nanofibers, 30gsm and 60gsm, on the filters as well as two different resins, cation and anion exchange resins. The results clearly show that the presence of the IER significantly improves the filtration efficiency over the same material without the IER. With a 30 gsm nanofiber matrix, the LRV increases from 0.76 without and IER to 1.92 using an anion exchange resin and to 1.99 using a cation exchange resin. With a 60 gsm nanofiber matrix the LRV increases from 0.97 to 1.91 and 2.18 for an anion and cation exchange resin respectively.

The capture of nanoparticles from aerosols is critical in many fields, including protective clothing, respirators, air cabin filters, indoor air purifiers, and industrial air purification systems. The design of fibrous filters is based on the fact that filtration behavior is highly dependent on filter structure, particle size, and flow pattern. In general, filtration mechanisms that rely on mechanical capture include interception, diffusion, and inertial impaction. A minimum at the most penetrating particle size (MPPS) usually exists between 0.05 and 0.5 µm due to the combined action of these filtration mechanisms, which have different sensitivities to particle size. The smaller the average fiber diameter the lower the MPPS.

Utilization of nanofibers has become an emerging approach to enhance air filtration efficiency. Filters made of nanofibers with diameter less than 1 µm with large specific surface is particularly promising. The submicron particle capture efficiency of filtration materials made from nanofibers is much greater than the efficiency of filtration materials with the same basis weight made from microfibers. The filtration performance of fibrous filters is typically measured by the quality factor (QF), also known as the figure of merit, which is the ratio of the penetration rate of particles to the pressure drop across the filter.

$$Q F = - l n \left(P\right) / Δ p$$

P or permeability is equal to 1-E where E is the total filtration efficiency of the filter. A dense and thick filter is often more efficient in particle filtration and has a higher flow resistance or pressure drop Δp, whereas a porous and thin filter is more air permeable but has a higher penetration rate for particles and is therefore less efficient in terms of filtration. Hence, improvement of filter efficiency is generally accompanied by an increase in the pressure drop.

The pressure drop is significant greater for nanofiber filters than microfiber-based filters as the theoretical pressure drop Δ p follows in inversely correlated with the square of the fiber diameter. Therefore, a nanofiber filter with an average 100 nm fiber diameter will have a one hundred times greater pressure drop than a microfiber filter of the same basis weight with a one micron average diameter. Other than the large specific surface of nanofibers that lead to high pressure drop, another factor leading to pressure drop is the smaller pores (on the order several micrometers or less depending on the basis weight of the nanofiber filter) of the nanofiber mat versus the larger pores (tens of micrometers) for the microfiber filter. The QF for nanoparticles is observed to decline with a decrease in nanofiber diameter. It is believed that, for nanoparticles, the pressure drop increases more rapidly than the filtration efficiency due to diffusion.

The disclosure relates to an improved non-woven filtration material that can maintain high capture efficiency and low pressure drop. Preferably, a significant portion of the fibers should have a diameter less than or equal to about 1000 nanometers, more preferably less than or equal to about 500 nanometers. When the nanofiber matrix layer is produced by a melt-film fibrillation process, the nanofibers have a high loft resulting in a low stacking density and therefore high porosity as compared to electrospun nanofibers that tightly stack on top of each other when under pressure.

Filtration performance has been found to decrease with face velocity. This phenomenon is caused by the much lower likelihood for particles to collide on fibers through diffusion filtration at a smaller face velocity. Enhanced QF has also been observed in a thick layer alone in comparison to multiple thin layers of electrospun nanofibers, as multilayer filters have greater uniformity and smaller fiber sizes.

We have found that a coform fiber filter of homogeneously distributed nanofibers and microparticles to significantly improve both the permeability and QF at an MPPS of less than 0.1 µm which is the median diameter size of the smallest virus aerosol droplets. It is hypothesized that a polymeric nanofiber matrix with large numbers of nanofibers intermixed with coarser microparticles will result in structures with greater filtration performance and lower pressure drop than separate layers of microfibers and nanofibers. It has also been shown that filter packing density and pore radius are functions of fiber radius. The smaller the fiber diameter the lower the filter material packing density and smaller the pore size. As the pore size decreases both the capture efficiency and pressure drop increase.

Considerable increase in efficiency may be gained from thicker nanofiber-microparticle coform layers. While pressure drop increase linearly with layer thickness, the filtration performance increases substantially in the MPPS range. We have specifically found the QF of a a 120 gsm coform filter including homogeneously interspersed with 60 gsm of nanofibers and 60 gsm of microparticles to be substantially higher than the 60 gsm nanofiber layer alone.

It is also desirable to have a certain amount of fine microparticles throughout the matrix layer as it provides a scaffold against which higher pressure can be applied without collapsing the nanofiber matrix and reducing pore size. The air permeability is dependent on the percentage of microparticles contained in the fiber matrix. If the percentage is too low the scaffold will collapse and the loftiness of the structure can no longer be maintained. This is turn will reduce pore size and increase pressure drop as porosity drops together with the closing of pores. On the other hand, if the percentage of microparticles becomes too large then efficiency of the filter will be reduced. An optimal filter layer structure is therefore a structure which can maintain its pore size over time.

### Process for Making High Efficiency Particle Air Filtration Material

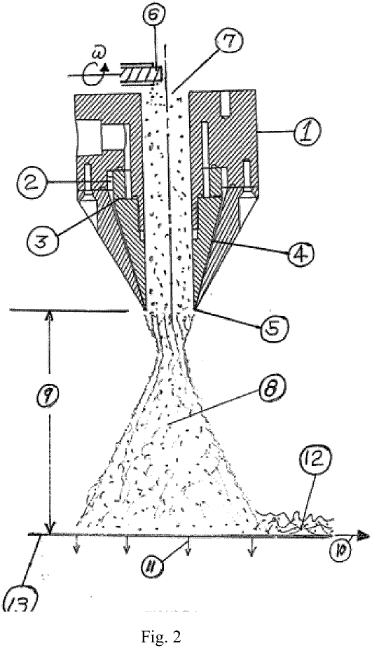

FIG. 2 illustrates a process for making the material. The process is detailed in the jointly owned U.S. Pat. 8,808,594 hereby included in its entirety. The nozzle 1 shown in cross-section in FIG. 2 is an axisymmetric design. Heated gas is injected into a swirl chamber 2 by two orifices, creating a swirling rotating flow about the axis of the nozzle. A heated polymer melt, comprising a mixture of substances is injected into the swirl chamber 2 through orifices 3. The swirling, rotating gas flow mixes with the polymer (mixture of substances) and forms a two-phase flow. The two-phase flow subsequently traverses a narrow flow channel 4 thereby transferring the two-phase flow to the exit gap 5. At the exit gap the two-phase flow is broken into discrete elements or streams which are attenuated to become polymeric fibers 6. The axisymmetric nozzle 1 contains a hollow cylinder 7. The hot gas jet issuing from axisymmetric gap 5 creates a negative pressure in this region which aspirates gas through the hollow cylinder 7. The figure shows how the ion exchange resins (IER) 8 are substantially enveloped and contained within the fiber making stream. This is accomplished by making the aspiration section of the nozzle capable of accommodating an injection tube which feeds the IER powder/particles into the desired region of flow. In this manner, the IER will be contained within the fiber/jet flow and will mix with and thermally bond to the nanofiber filaments as they are being formed. The absence of binders ensures that the maximum surface area of the EIR particles/powder remains available for adsorption of virus particles. The IER are thereby homogeneously distributed throughout the fiber matrix 12. The nozzle gap 5 is located at a distance 9 from a collecting surface 13. The fibers with attached IER are formed into a sheet or web material by vacuum 11 on the moving collection surface 13.

### High Efficiency Virus Air Filtration Material

The present inventors have surprisingly found that the virus removal efficiency of the filter can be selectively enhanced based on principles of ionic interaction between electrostatically surface charged virus particles and ion exchange resins dispersed within a nanofiber matrix. Without being bound by theory, the principle is that a charged particle such as a virus in an aerosol droplet will be attracted and bind to a resin which is oppositely charged to that of the virus droplet (the ion exchanger) forming an ionic bond with the resin. Viruses as well as other (bio-)colloids possess a pH-dependent surface charge in polar media such as water. This electrostatic charge determines the mobility of the soft particle in an electric field and thus governs its colloidal behavior which plays a major role in virus sorption processes. The pH value at which the net surface charge switches its sign is referred to as the isoelectric point (abbreviations: pI or IEP) and is a characteristic parameter of the virion in equilibrium with its environmental water chemistry. If the environmental pH is lower than the isoelectric point the virus particle will have a net positive charge while if the environmental pH is higher than the isoelectric point the virus particle has a negative net charge. The inventors have discovered that it is possible to enhance the clearance of virus particles by physical adsorption of virus particles from an aerosol onto a filter material based on the electric charge of the virus particle. To the best knowledge of the inventors, the ion exchange filtration process had never previously been applied to an aerosol.

The charged virus particles have a stronger affinity to the fixed ions of the IEX resins than the counterions on the resins, and adsorb to the surface of the IEX resins by tight electrostatic interaction where they remain bound. It has been shown that virus particles in aerosol droplets generally have a positively charge outer layer at the air-liquid boundary and a negatively charged core. Consistent with these findings, the inventors found that cation exchange resins dispersed throughout a nanofiber matrix demonstrated a stronger virus clearance than anion exchange resins. Strongly acidic cation exchange resins also exert stronger electrostatic forces than weakly acidic resins. Therefore, in a preferred embodiment, the ion exchange resins comprise strongly acidic cation exchange resins. In an embodiment of the disclosure, cation exchange resins also serve as desiccants, whereby the water content of virus particles is adsorbed to the interior of the porous cation-exchange resins.

The majority of cation exchange resins and anion exchange resins are based on the copolymerization of styrene and a cross-linking agent, divinylbenzene (DVB) to produce a 3-dimensional cross-linked structure. The degree of cross-linking is governed by the ratio of DVB to styrene. These cross-linked co-polymers swell in the presence of organic solvents, but have no ion exchange properties. To convert the co-polymers to water-swellable particles or gels with ion exchange properties, ionic functional groups are added to the polymeric network. Cation exchange resins are prepared by sulfonating the benzene rings in the polymer. The SO3- groups are permanently fixed to the polymer network to give a negatively charged matrix and exchangeable, mobile positive hydrogen ions. The hydrogen ions can be exchanged on an equivalent basis with other cations such as Na+ , Ca2+ , K+ or Mg2+ , to maintain neutrality of the polymer. For example, 2 H+ ions are exchanged for 1 Ca2+ ion. The exchangeable ions are called counter-ions. Anion exchange resins require 2 reactions: chloromethylation and amination.

### Process for Removal of Virus Particles From Air

The ion exchange IEX process of the disclosure is as follows: a bioaerosol containing submicron viral particles passes through a nanofiber matrix where IEX resins are homogenously distributed. IEX resins are either cation exchange (CEX) resins with fixed negative ions and mobile positive counterions or anion exchange (AEX) resins with fixed positive ions and mobile negative counterions. The virus particles have an electrical charge based on the isoelectric point of the (IEP). When the filtration occurs under conditions where the viruses are negatively charged, virus clearance is due to electrostatic interactions with the positively charged anion exchange resin. When the filtration occurs under conditions where the viruses are positively charged, virus clearance is due to electrostatic interactions with the positively charged anion exchange resin. In order to capture both positively and negatively charged viruses both cation and anion exchange resins may be distributed through the matrix.

The capture efficiency due to this mechanism is directly proportional to the charge and inversely related to the air velocity. The charge can be increased by the amount of cross-linking of the styrene resins. A typical crosslinking rate is 8%. In a preferred embodiment, a crosslinking rate of 10% or greater is preferred.

### EMBODIMENTS

All the test are performed with a 2% sodium chloride aerosol solution at a flow rate of 5.33 cm/s.

TABLE 2

below summarizes the results.

| Matrix | MPPS (nm) | Efficiency | Resistance (Pascal) | Quality factor |
|---|---|---|---|---|
| 240 gsm nanofiber 240 gsm IEX 35 | 180 | 99.997% | 420 | 0.0248 |
| 240 gsm nanofiber 240 gsm IEX 65 | 187 | 99.7% | 190 | 0.0305 |
| 120 gsm nanofiber 120 gsm IEX 65 | 187 | 96% | 120 | 0.0268 |
| 120 gsm nanofiber | 165 | 98% | 165 | 0.0237 |

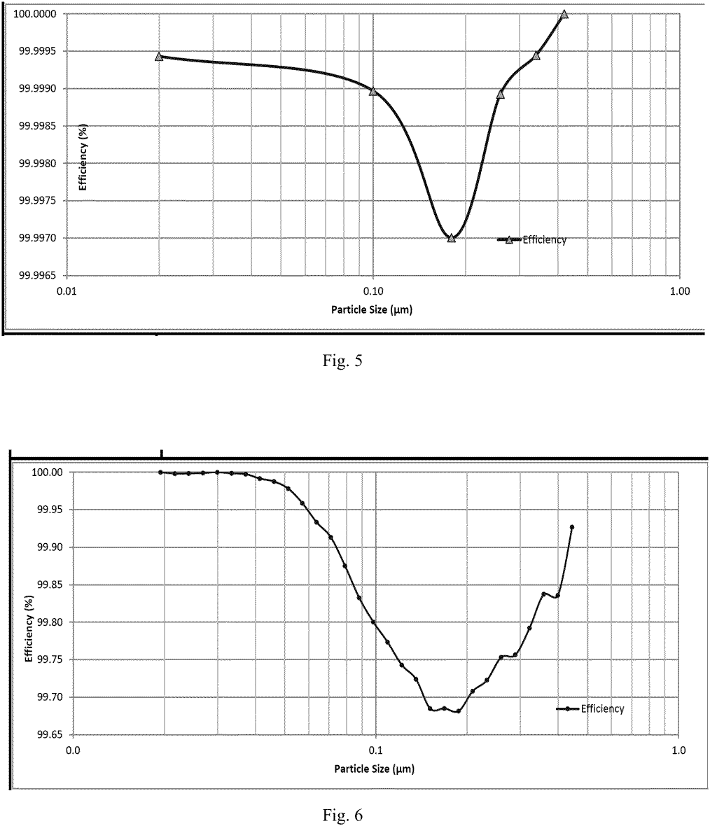

FIG. 5 illustrates a first embodiment with a matrix consisting of 240 gsm nanofibers and 240 gsm resins @ 65 micron diameter.

FIG. 6 illustrates a second embodiment with a matrix consisting of 240 gsm nanofibers and 240 gsm resins @ 35 micron diameter.

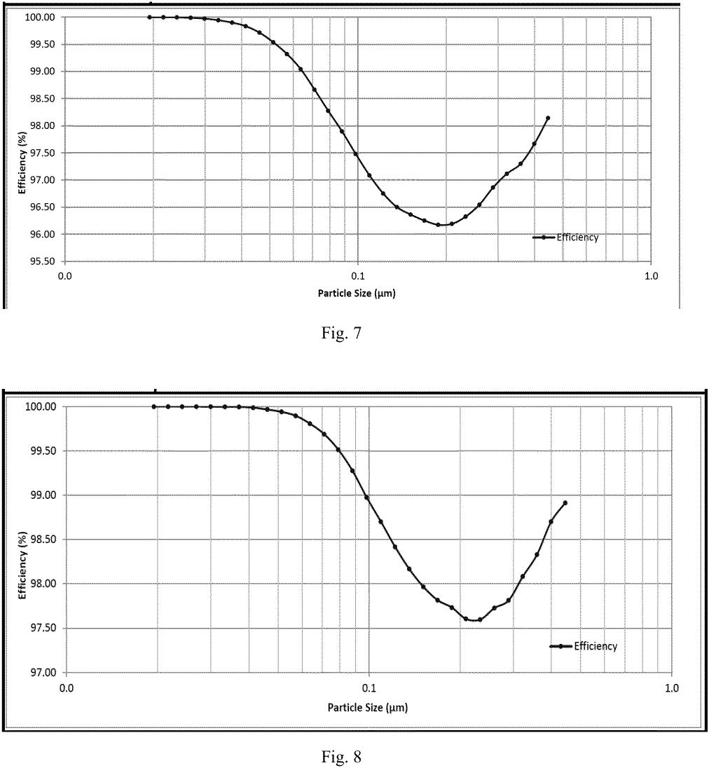

FIG. 7 illustrates a third embodiment with a matrix consisting of 120 gsm nanofibers and 240 gsm resins @ 65 micron diameter.

FIG. 8 illustrates a fourth embodiment with a matrix consisting of 120 gsm nanofibers.

It is apparent that MPPS is strongly correlated with pore size. The smallest pore sizes are in the matrix with nanofibers only at around 165 nm. Pore size increases as resins are added as the matrix becomes more porous. Resistance decreases while efficiency drops. Nevertheless, the overall quality factor QF increases by amount 15%. As the matrix thickness doubles, MPPS stays relatively constant with efficiency increasing as well as resistance. Nevertheless, QF increases by another 15% over the thinner material. Smaller resins result in large increases in in efficiency as well as resistance with only a small increase in QF over the nanofiber only matrix.

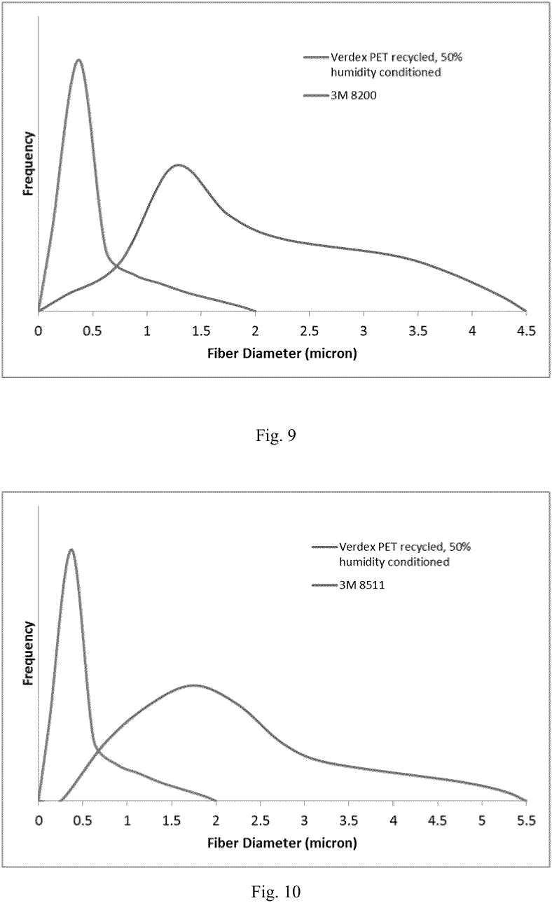

FIGS. 9 and 10 illustrate the nanofiber size distribution of an embodiment of the fibrillated nanofiber matrix layer according the disclosure compared to the microfibers size distribution of two meltblown microfiber matrix of the prior art. The nanofiber matrix of the disclosure provides for a much improved filtration efficiency over a microfiber matrix of the same basis weight.

| Fiber type | median (µn) | average (µn) | std dev (µn) |
|---|---|---|---|
| Verdex PET recycled, 50% humidity conditioned | 0.41 | 0.54 | 0.45 |
| 3 M 8200 | 1.58 | 1.87 | 0.99 |
| 3 M 8511 | 2.00 | 2.23 | 1.13 |

The basis weight of the charged particles dispersed throughout the fiber matrix is also critical to the filtration efficiency. Generally, a higher basis weight will increase the overall packing density of the filtration material and reduce pore size. The filtration efficiency is optimized by having the ion exchanger (IER) microparticles homogeneously distributed throughout the fibrous matrix. The greater the surface area of the IER particles the greater their capacity at filtering out the virus particles from the aerosol. Smaller IER particles will have a greater surface area relative to their basis weight compared to larger particles. Therefore, the highest filtration efficiency will be achieved with the smallest possible IER particle. Unlike other non-woven filtration materials where particulates are held into the material from fiber entanglement, the nanofiber matrix of the disclosure is able to contain particles smaller than the average pore size since the particles are attached and stuck to the fibers while they are still tacky. In an embodiment of the disclosure, the median diameter of the IER is less than 65 microns.

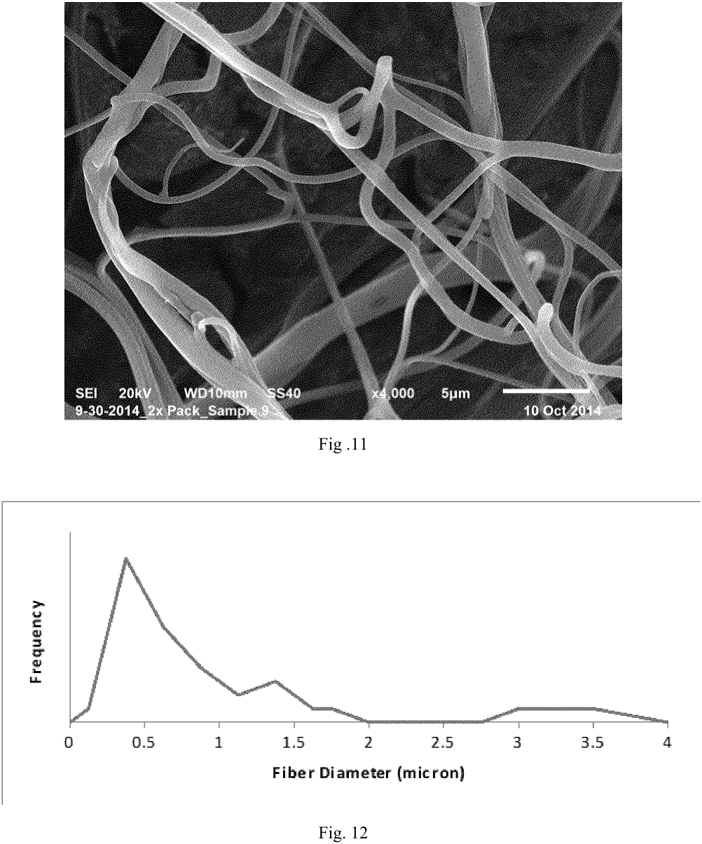

FIG. 11 shows the representative FE-SEM image of melt film fibrillated nanofibers produced according to the disclosure revealing that the as-spun nanofibers exhibit randomly oriented 3D nonwoven structures. One interesting observation here is the formation of 3D scaffold-like composite fibrous webs comprising bimodal fiber diameter distributions (FIG. 12). The microfibers with diameters ranging from 3-3.5 microns acted as a skeletal framework for the thinner nanofibers with an average diameter of about 500 nm distributed throughout through the 3D fibrous matrix.

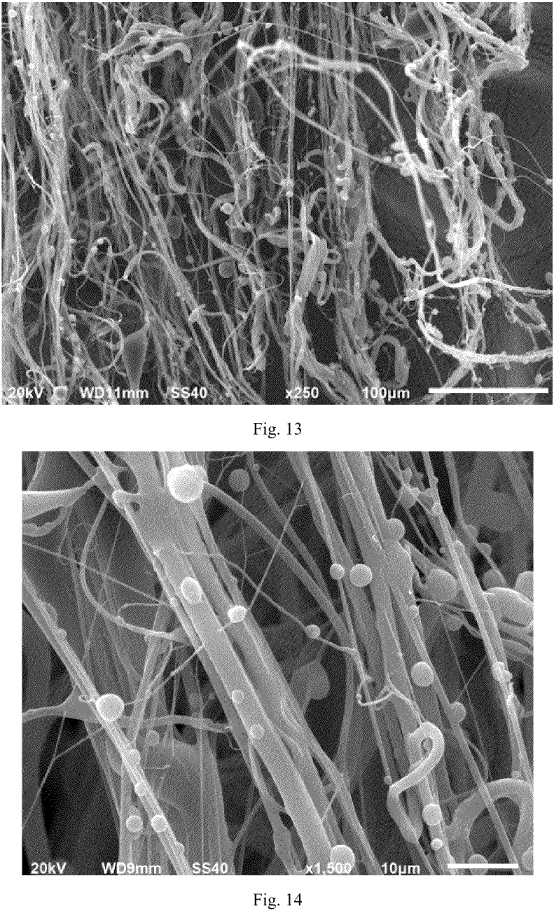

A stainless steel reactor vessel (volume = 0.5 1) was charged with 196 g of polypropylene (Aldrich 428116) and 4 g polypropylene (Marco Polo) and 4 g of panalane H-300E (Lipo Chemicals). The mixture was heated to 211 C and pressurized to 40 psig. The heated and pressurized mixture was forced through a 140 micron rated filter and then fed into the nozzle. The heated polymer mixture was injected into a swirl chamber through 8 orifices, each with diameter = 0.51 mm. Heated air at 258 C and 60 psig was injected into a swirl chamber by two orifices, each with diameter = 3.18 mm. The diameter of the nozzle exit gap was 2.54 cm and gap width was approximately 0.53 mm. The nozzle was placed approximately 25.4 cm from a perforated plate collecting surface. Reemay scrim was pulled across the collecting surface with a vacuum flow pulled through the Reemay and under the jet being issued through the nozzle exit gap. A 35 micron diameter resin was fed into the nozzle by a screw feeder (Schenck Accurate 100 with 1.9 cm diameter screw) at a setting of 999. The collected material had a basis weight of approximately 123.5 gsm. The fiber portion of the material basis weight was 45 gsm and the powder portion of the basis weight was 78.5 gsm. Scanning electron microscope (SEM) pictures of the collected material is shown in FIGS. 13 and 14.

### EXAMPLES

### Example 1

The table below illustrates examples of nanofiber webs comprised of layers of nanofibers only and composites with spacers inserted between the nanofiber layers.

| Example | | Test Velocity fpm | Efficiency % | Penetration % | Resistance mmH₂O | Calc Perm (fpm/0.5″) | Pressure Drop in H₂O | FOM (cm/ sec)/cm Hg |
|---|---|---|---|---|---|---|---|---|
| 1 | Only Fibers | 10.5 | 77.547 | 22.453 | 7.164 | 18.61 | 0.28 | 152 |
| 2 | Comp. | 10.5 | 90.797 | 9.203 | 6.404 | 20.82 | 0.25 | 271 |
| 3 | Only Fibers | 10.5 | 74.313 | 25.687 | 28.697 | 4.65 | 1.13 | 34 |
| 4 | Comp. | 10.5 | 97.782 | 2.218 | 10.504 | 12.70 | 0.41 | 263 |
| 5 | Only Fibers | 10.5 | 87.542 | 12.458 | 76.856 | 1.71 | 3.03 | 20 |
| 6 | Comp. | 10.5 | 97.161 | 2.839 | 9.395 | 14.19 | 0.37 | 275 |
| 7 | Only Fibers | 10.5 | 91.253 | 8.747 | 183.938 | 0.72 | 7.24 | 10 |
| 8 | Comp. | 10.5 | 99.863 | 0.137 | 17.193 | 7.76 | 0.68 | 278 |

### Example 2

The table below illustrates various examples of nanofiber webs according to the disclosure.

| Sample Code | Product Description | MERV Rating | Basis Wt. (gsm) | Particle size (µm) | Efficiency at 0.35 µm | Air Flow Speed (fpm) | Initial Resistance (in. H₂O) | ASHRAE Dust Holding (g/ft²) | Final Resistance (in. H₂O) | ISOFINE A-2 Dust Holding | Final Resistance (in. H₂O) |
|---|---|---|---|---|---|---|---|---|---|---|---|
| 604 | Glass Fiber | 9 | 70 | 0.35 | 17 | 10.5 | 0.055 | 2.21 | 1 | 5 | 1 |
| 804 | Glass Fiber | 13 | 70 | 0.35 | 55 | 10.5 | 0.18 | 1.55 | 1 | 3.83 | 1 |
| 904 | Glass Fiber | 13 | 70 | 0.35 | 57 | 10.5 | 0.18 | 1.37 | 1 | 5.06 | 1 |
| 0805-6A | Verdex | 11 | 63 | 0.35 | 23 | 10.5 | 0.072 | | | 10.5 | 1 |
| 0805-5A | Verdex | 12 | 67 | 0.35 | 31 | 10.5 | 0.105 | | | 11.3 | 1 |
| 0717-2 | Verdex | 13 | 38 | 0.35 | 68 | 10.4 | 0.18 | | | 7.1 | 1 |
| 0711-1 | Verdex | 14 | 136 | 0.35 | 78 | 10.4 | 1.35 | | | | |
| 0717-4 | Verdex | 15 | 93 | 0.35 | 82 | 10.4 | 0.61 | | | 3.4 | 1 |
| 0805-7A | Verdedx | 16 | 54 | 0.35 | 93 | 10.4 | 1 | | | | |
| 0710-3 | Verdex | 16 | 132 | 0.35 | 99.8 | 10.4 | 2.22 | | | | |

1. A filtration media for removing airborne particulates from an aerosol comprising a coform fibrous matrix comprising a first population of fibrillated polymeric nanofibers and a second population of fine particles homogenously dispersed throughout the fibrous matrix,
wherein the permeability of the coform fiber matrix is greater than the permeability of a fibrous matrix comprising the first population of nanofibers formed without the second population of fine particles,
wherein the porosity of the coform fiber matrix is less than the porosity of a fibrous matrix filter comprising the first population of nanofibers formed without the second population of fine particles,
wherein the filtration efficiency is greater than 99.99% for airborne particulates with a median diameter of less than 0.3 microns; and the pressure drop across the filter is less than 200 Pascal at an aerosol face velocity of 5.3 m/s.

2. The filter of claim 1 wherein the fine particles have a median diameter smaller than 65 microns and preferably smaller than 35 microns.

3. The filter of claim 2 wherein the fine particles comprise at least 50% by weight of the fibrous matrix.

4. The filter of claim 3 wherein the nanofibers have a median diameter smaller than 0.5 microns.

5. The filter of claim 4 wherein the coform fibrous matrix has a porosity greater than 85%.

6. The filter of matrix of claim 5 further comprising a third population of fibrillated microfibers with an average diameter of between 2 and 5 microns.

7. The filter of claim 6 wherein the microfibers are made from polymer at the opposite end of the triboelectric range from the nanofibers.

8. A filter for the removal of airborne virus particles from an aerosol comprising a coform fibrous matrix comprising a population of fibrillated polymeric nanofibers and a population of ion-exchange resins homogenously distributed throughout the coform matrix,
wherein the filter has a virus particle clearance with a log₁₀ reduction value greater than 3, preferably greater than 4 for virus particles having a median diameter of less than 0.1 microns.

9. The filter of claim 8 wherein the filtration efficiency is greater than 99.99% for virus particles with a median diameter of less than 0.3 microns and the pressure drop across the filter is less than 200 Pascal at an aerosol face velocity of 5.3 m/s.

10. The filter of claim 8 wherein the ion exchange resins have a median diameter smaller than 65 microns and preferably smaller than 35 microns.

11. The filter of claim 10 where the ion exchange resins include a mixture of anion exchange resins and cation exchange resins.

12. The filter of claim 11 wherein the ion exchange resins comprise strongly acidic cation exchange resins.

13. The filter of claim 12 where the cation exchange resins comprise sulphonated cross-linked polystyrene derivatives with a degree of crosslinking greater than 8%, preferably greater than 10%.

14. The filter of claim 8 wherein the ion exchange resins comprise a biocidal agent selected from the group consisting of iodine, bromine, chlorine, propanol, ethanol, isopropyl alcohol and benzalkonium chloride and mixtures thereof.

15. A process for removing virus particles from an aerosol comprising the steps of:
passing the aerosol through a filter comprising a coform fibrous matrix comprising a population of fibrillated polymeric nanofibers and a population of ion exchange resins homogenously dispersed throughout the matrix,
capturing the virus particles in the coform matrix,
binding the virus particles to the surface of the ion exchange resins,
desiccating the virus particles on contact with the ion exchange resins.

16. The process of claim 15 comprising the further step of neutralizing the captured virus particles by contacting the virus particles with a water-soluble biocidal agent.

17. The process of claim 16 wherein the biocidal agent is selected from the group consisting of iodine, bromine, chlorine, propanol, ethanol, isopropyl alcohol and benzalkonium chloride and mixtures thereof.

18. The process of claim 15 wherein the filter provides at least a log₁₀ reduction value greater than 3, preferably greater than 4 for virus particles with a diameter smaller than 0.1 microns.

19. The filter of claim 15 where the ion exchange resins include a mixture of anion exchange resins and cation exchange resins.

20. The process of claim 19 wherein the ion exchange resins comprise strongly acidic cation exchange resins.
